(19) United States
(12) Patent Application Publication
(10) Pub. No.: US 2011/0202210 A1
(43) Pub. Date: Aug. 18, 2011

(54) VEHICLE AND CONTROL METHOD THEREOF

(76) Inventor: Hideaki Goda, Aichi-ken (JP)

(21) Appl. No.: 12/517,677

(22) PCT Filed: Nov. 22, 2007
(86) PCT No.: PCT/JP2007/072620

§ 371 Date: Jun. 4, 2009

(30) Foreign Application Priority Data
Dec. 4, 2006 (JP) 2006-327275

(51) Int. Cl. B60W 20/00; B60W 10/06; B60W 10/08

(52) U.S. Cl. 701/22; 903/930

(57) ABSTRACT

When motor driving is not permitted even though the EV switch is switched on, a warning sound is emitted from the speaker to the driver's cabin and information relating to a condition that is not established among the motor driving permission conditions is displayed on the display that is provided in the vicinity of the driver's seat. Therefore, more detailed information regarding the fact that motor driving is not permitted can be notified.

### TECHNICAL FIELD

The present invention relates to a vehicle and a control method of a vehicle.

### BACKGROUND ART

Conventionally, as this kind of vehicle, a vehicle has been proposed that includes an engine that outputs a driving power to an axle, a generator that is driven by the engine, a motor that outputs a driving power to an axle, and a battery that provides and receives electric power to and from the generator and motor, the vehicle performs motor driving that drives using a power from the motor in a state in which operation of the engine is stopped (for example, see Patent Document 1). According to this vehicle, when a state of charge of the battery is below a state of charge necessary for motor driving in a case that an instruction has been given to perform motor driving, charging of the battery by the generator is performed and an NG lamp that displays an indication to the effect that motor driving can not be performed is lit to thereby inform the driver that motor driving is not possible.

[Patent Document 1] Japanese Patent Laid-Open No. 2003-23703

### DISCLOSURE OF THE INVENTION

The vehicle disclosed in the above Patent Document can inform that the motor driving is not possible by on/off of the NG lamp. However, it is impossible to inform more detailed information such as reasons of impossibility of motor driving.

An object of a vehicle and a control method of the same of the present invention is, in the vehicle that is capable of driving using a power from an internal combustion engine and a power from a motor, to inform more detailed information when motor driving is not performed even though an instruction has been given to perform motor driving that drives using a power from the motor in a state in which an operation of the internal combustion engine has been stopped.

In order to achieve the above object, the vehicle and the control method thereof in accordance with the present invention adopt the following means.

The present invention is directed to a vehicle that is capable of driving using a power from an internal combustion engine and a power from a motor, the vehicle includes: a motor driving designation unit that designates motor driving that drives using a power from the motor in a state in which an operation of the internal combustion engine has been stopped; a notification unit that notifies predetermined information; and a control module that, when the motor driving is designated by the motor driving designation unit, when predetermined motor driving permission conditions that permit the motor driving are established, controls the internal combustion engine and the motor such that the vehicle is driven by the motor driving and also controls the notification unit such that information to the effect that the motor driving is performed is notified, and when the predetermined motor driving permission conditions are not established, controls said internal combustion engine and the motor so as to drive in a state in which at least the internal combustion engine is operated and also controls the notification unit such that information relating to a fact that the motor driving is not permitted is notified.

According to the vehicle of the present invention, when an instruction has been given to perform motor driving, when predetermined motor driving permission conditions that permit motor driving are not established the internal combustion engine and the motor are controlled so as to perform driving in a state in which at least the internal combustion engine is operated and the notification unit is also controlled such that information relating to a fact that motor driving is not permitted is notified. As a result, when motor driving is not performed even though an instruction to perform motor driving has been given, information can be notified to a driver that is more detailed in comparison to a vehicle that only notifies a driver to the effect that motor driving will not be performed.

In the vehicle of the present invention, the control module may be a module that controls the notification unit such that, as the information relating to a fact that the motor driving is not permitted, information to the effect that the motor driving is not permitted and information that relates to the predetermined motor driving permission condition that is not established are notified. Thus, information to the effect that motor driving is not permitted and information relating to a motor driving permission condition that is not established can be notified to the driver.

Also, in the vehicle of the present invention, the control module may be a module that, when a predetermined motor driving stoppage condition that stops the motor driving in the course of the vehicle being driven by the motor driving is established, controls the internal combustion engine and the motor such that at least an operation of the internal combustion engine is started and also controls the notification unit such that information relating to a fact that the motor driving is stopped is notified. Because information relating to the fact that motor driving has stopped is notified to the driver when a predetermined motor driving stoppage condition that stops motor driving in the course of the vehicle being driven by motor driving is established, more detailed information can be notified to the driver. In this case, the control module may be a module that, when it is predicted that the motor driving will stop in the course of the vehicle being driven by the motor driving, controls the notification unit such that information relating to a fact that stoppage of the motor driving is predicted is notified. Thus, information relating to a fact that stoppage of the motor driving is predicted can be notified to the driver.

Further, in the vehicle of the present invention, the notification unit may be a unit that notifies the information by means of a display output or a sound output.

The present invention is directed to a control method of a vehicle that includes an internal combustion engine capable of outputting a driving power to an axle, a motor capable of outputting a driving power to an axle, a motor driving designation unit that designates motor driving that drives using a power from the motor in a state in which an operation of the internal combustion engine has been stopped, and a notification unit that notifies predetermined information. In the control method of a vehicle, when the motor driving is designated by the motor driving designation unit, when predetermined motor driving permission conditions that permit the motor driving are established, the internal combustion engine and the motor are controlled such that the vehicle is driven by the motor driving and the notification unit is also controlled so as to notify information to the effect that the motor driving is performed, and when the predetermined motor driving permission conditions are not established, the internal combustion engine and the motor are controlled so as to drive in a state in which at least operation of the internal combustion engine is continued and the notification unit is controlled such that information relating to a fact that the motor driving is not permitted is notified.

According to the control method of a vehicle of the present invention, when an instruction for motor driving has been given, when predetermined motor driving permission conditions that permit motor driving are not established, the internal combustion engine and the motor are controlled such that driving is performed in a state in which at least operation of the internal combustion engine is continued, and the notification unit is also controlled such that information relating to the fact that motor driving is not permitted is notified. As a result, when motor driving is not performed even though an instruction to perform motor driving has been given, the vehicle can notify the driver with more detailed information in comparison to a control method of a vehicle that only notifies a driver to the effect that motor driving will not be performed.

In the control method of a vehicle of the present invention, the notification unit may be characterized by being controlled such that, as the information relating to a fact that the motor driving is not permitted, information to the effect that the motor driving is not permitted and information that relates to the predetermined motor driving permission condition that is not established are notified. Thus, information to the effect that motor driving is not permitted and information relating to a motor driving permission condition that is not established can be notified to the driver.

Also, the control method of a vehicle of the present invention may be characterized by, when a predetermined motor driving stoppage condition that stops the motor driving in the course of the vehicle being driven by the motor driving is established, the internal combustion engine and the motor are controlled such that at least an operation of the internal combustion engine is started and the notification unit is also controlled such that information relating to a fact that the motor driving is stopped is notified. Because information relating to the fact that motor driving has stopped is notified to the driver when a predetermined motor driving stoppage condition that stops motor driving in the course of the vehicle being driven by motor driving is established, more detailed information can be notified to the driver.

### BRIEF DESCRIPTION OF THE DRAWINGS

FIG. 1 is a configuration diagram that shows an outline of the configuration of a hybrid vehicle 20 as one embodiment of the present invention;

FIG. 2 is a flowchart that shows one example of an EV switch on time control routine that is executed by the hybrid electronic control unit 50 of the embodiment; and

FIG. 3 is a flowchart that shows an example of a motor drive time control routine that is executed by the hybrid electronic control unit 50 of the embodiment.

### BEST MODE FOR CARRYING OUT THE INVENTION

Hereinafter, the best mode for carrying out the invention will be described with reference to embodiments.

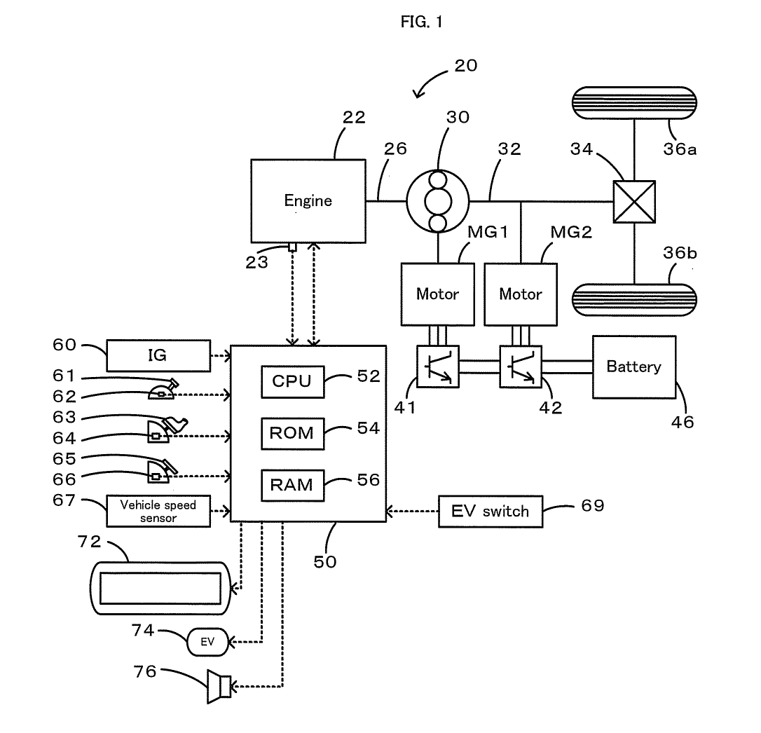

FIG. 1 is a configuration diagram that shows an outline of the configuration of a hybrid vehicle 20 as one embodiment of the present invention. As shown in FIG. 1, the hybrid vehicle 20 of this embodiment includes an engine 22 that is configured as an internal combustion engine that outputs a power by using a hydrocarbonaceous fuel such as gasoline or diesel oil; a planetary gear 30 in which a crankshaft 26 of the engine is connected to a carrier, and a ring gear is connected to a drive shaft 32 that is connected through a differential gear 34 to drive wheels 36a and 36b; a motor MG1 configured as a synchronous motor generator in which a rotor is connected to a sun gear of the planetary gear 30; a motor MG2 configured as a synchronous motor generator in which a rotor is connected to the drive shaft 32; a battery 46 connected to the motors MG1 and MG2 through inverters 41 and 42; and a hybrid electronic control unit 50 that controls the entire vehicle.

The hybrid electronic control unit 50 is constructed as a microprocessor including a CPU 52, a ROM that stores processing programs, a RAM 56 that temporarily stores data, and a non-illustrated input-output port, and a non-illustrated communication port. The hybrid electronic control unit 50 receives various inputs via the input port: an ignition signal from an ignition switch 60, a gearshift position SP from a gearshift position sensor 62 that detects the current position of a gearshift lever 61, an accelerator opening Acc from an accelerator pedal position sensor 64 that measures a step-on amount of an accelerator pedal 63, a brake pedal position BP from a brake pedal position sensor 66 that measures a step-on amount of a brake pedal 65, a vehicle speed V from a vehicle speed sensor 67 and an on/off signal from an EV switch 69 which designates motor driving that drives using only a power from the motor MG2 in a state in which an operation of the engine 22 has been stopped. The hybrid electronic control unit outputs, via the output port, signals such as a display signal to a display 72 that is installed in the vicinity of the driver's seat and that displays map information from an unshown navigation system and information relating to the vehicle with characters and symbols and the like, a lighting signal to an indicator 74 that is installed in the vicinity of the driver's seat and that lights up when motor driving is permitted, and a sound signal to a speaker 76 that outputs a sound into the interior of the vehicle. The hybrid electronic control unit 50 receives signals that are necessary for operational control of the engine 22 such as a cooling water temperature Tw from a water temperature sensor 23 that detects the temperature of cooling water of the engine 22, and carries out operational control of the engine 22. Further, the hybrid electronic control unit receives signals that are necessary to drive and control the motors MG1 and MG2, such as signals from an unshown rotational position detection sensor that detects the rotational position of a rotor of each of the motors MG1 and MG2, and drives and controls the motors MG1 and MG2. Furthermore, the hybrid electronic control unit 50 receives signals that are necessary for managing the battery 46, such as charge and discharge currents from an unshown electric current sensor that is mounted to a power line from the battery 46, and manages the battery by calculating a state of charge SOC based on an integrated value of the charge and discharge currents.

The hybrid vehicle 20 of the embodiment thus constructed calculates a torque demand to be output to the drive shaft 32 based on a vehicle speed V and an accelerator opening Acc, which corresponds to a driver's step-on amount of an accelerator pedal 63. The engine 22 and the motors MG1 and MG2 are subjected to operation control to output a required level of power corresponding to the calculated torque demand to the drive shaft 32. The operation control of the engine 22 and the motors MG1 and MG2 selectively effectuates one of a torque conversion drive mode, a charge-discharge drive mode, and a motor drive mode. The torque conversion drive mode controls the operations of the engine 22 to output a quantity of power equivalent to the required level of power, while driving and controlling the motors MG1 and MG2 to cause all the power output from the engine 22 to be subjected to torque conversion by means of the planetary gear 30 and the motors MG1 and MG2 and output to the drive shaft 32. The charge-discharge drive mode controls the operations of the engine 22 to output a quantity of power equivalent to the sum of the required level of power and a quantity of electric power consumed by charging the battery 46 or supplied by discharging the battery 46, while driving and controlling the motors MG1 and MG2 to cause all or part of the power output from the engine 22 equivalent to the required level of power to be subjected to torque conversion by means of the planetary gear 30 and the motors MG1 and MG2 and output to the drive shaft 32, simultaneously with charge or discharge of the battery 46. The motor drive mode stops the operations of the engine 22 and drives and controls the motor MG2 to output a quantity of power equivalent to the required level of power to the drive shaft 32.

Next, the operations of the hybrid vehicle 20 of the present embodiment that is constructed in this manner are described, and in particular the operations when the EV switch 69 is switched on when driving while operating the engine 22, or when notifying information relating to motor driving in the course of driving in a motor operation mode (hereunder, referred to as “motor driving”) when the EV switch 69 has been switched on are described. First, the operations when the EV switch 69 has been switched on are described and thereafter the operations when notifying information relating to motor driving in the course of motor driving when the EV switch 69 has been switched on are described.

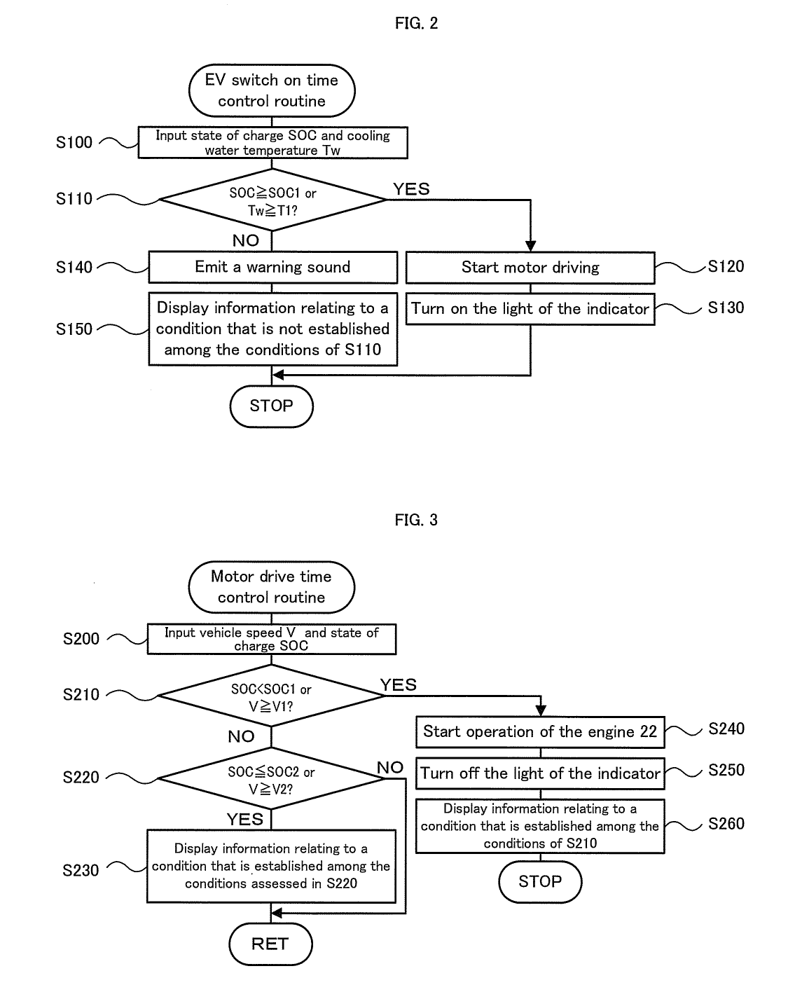

FIG. 2 is a flowchart that shows one example of an EV switch on time control routine that is executed by the hybrid electronic control unit 50 when the EV switch 69 is switched on. When the EV switch on time control routine is executed, the CPU 52 of the hybrid electronic control unit 50 executes processing that inputs data that is necessary for control, such as the cooling water temperature Tw of the engine 22 or the state of charge SOC of the battery 46 (step S100).

After data is input in this manner, the CPU 52 determines whether or not motor driving permission conditions that permit motor driving are established (step S110). This determination is performed by comparing the input state of charge SOC with a threshold value SOC1 as a lower limit of the state of charge SOC of the battery 46 that is necessary to perform motor driving for a predetermined time that is previously defined, and also comparing the cooling water temperature Tw and a threshold value T1 as a lower limit of the cooling water temperature of the engine 22 from which it can be determined that warming up of the engine 22 is completed. When the motor driving permission conditions are established, namely, when the state of charge SOC is at or above the threshold value SOC1 and the cooling water temperature Tw is at or above the threshold value T1, the CPU 52 determines that motor driving can be permitted since the state of charge of the battery 46 is sufficient for executing motor driving and warming up of the engine 22 is also completed, and controls the engine 22 and the motors MG1 and MG2 (step S120) so as to stop operation of the engine 22 and start motor driving, and outputs a lighting signal to the indicator 74 so that the indicator 74 lights (step S130), and thereafter ends the present routine. Thus, when the motor driving permission conditions are established, because the indicator 74 lights when motor driving starts, the driver can be notified that motor driving has started.

In contrast, when the motor driving permission conditions are not established (step S110), namely, when the state of charge SOC is less than the threshold value SOC1 or the cooling water temperature Tw is less than the threshold value T1, without executing control that starts motor driving, more specifically, while continuing driving while operating the engine 22, the CPU 52 outputs a sound signal to the speaker 76 so that a warning sound is emitted from the speaker 76 (step S140), and outputs a display signal to the display 72 so that information relating to a condition that is not established among the motor driving permission conditions is displayed on the display 72 (step S150), and thereafter ends the present routine. In the processing of step S150, for example, when it is determined in the processing of step S110 that the state of charge SOC is less than the threshold value SOC1, a message such as “state of charge of battery is insufficient” is displayed on the display 72 so that the driver can be made aware that the reason motor driving is not possible is that the state of charge of the battery 46 is insufficient, and when warming up of the engine 22 is not completed, a message such as “engine warm-up is not completed” is displayed on the display 72 so that the driver can be made aware that the reason motor driving is not possible is that warming up of the engine 22 is not completed. Thus, when motor driving is not permitted even though the EV switch 69 is switched on, since the driver is notified to that effect by a warning sound that is emitted from the speaker 76, the driver can recognize that motor driving is not permitted. Further, since information regarding a condition that is not established among the conditions that are assessed at step S110 is displayed on the display 72, the driver can be notified regarding the reason why motor driving is not permitted.

Next, operations performed when displaying information relating to motor driving during motor driving are described. FIG. 3 is a flowchart that shows an example of a motor drive time control routine that is executed by the hybrid electronic control unit 50 in the course of performing motor driving when the EV switch 69 is switched on. The processing from step S200 to step S230 of this routine is repeatedly executed at predetermined intervals of time (for example, at intervals of several milliseconds). When the motor drive time control routine is executed, the CPU 52 of the hybrid electronic control unit 50 executes processing that inputs data that is necessary for control such as a vehicle speed V from a vehicle speed sensor 67 or the state of charge SOC of the battery 46 (step S200).

After the data is input, the CPU 52 determines whether or not motor driving stoppage conditions that stop the motor driving are established (step S210). This determination is performed by comparing the input state of charge SOC and the threshold value SOC1, and also comparing the vehicle speed V and a threshold value V1 (for example, 60 km/h) as a lower limit of the vehicle speed from which it can be determined that it is necessary to start-up the engine 22 and perform driving by also using a power from the engine 22 because only the power from the motor MG2 is insufficient as a power that should be output to the axle.

When the motor driving stoppage conditions are not established, namely, when the state of charge SOC is at or above the threshold value SOC1 or the vehicle speed V is lower than the threshold value V1 (step S210), the CPU determines that it is possible to continue motor driving. Subsequently, the CPU 52 determines whether or not motor driving stoppage prediction conditions that predict that motor driving will stop if motor driving is continued as it is are established (step S220). This determination is performed by comparing the state of charge SOC with a threshold value SOC2 and also comparing the vehicle speed V with a threshold value V2. In this case, the threshold value SOC2 is set as a value that is somewhat larger than the threshold value SOC1 as the state of charge of the battery 46 that is sufficient for motor driving (for example, the threshold value SOC2 is three percent higher than the threshold value SOC1) and based on which it is possible to predict that the threshold value SOC1 will be reached if the motor driving is continued. Further, the threshold value V2 is set as a vehicle speed (for example, 50 km/h) that is somewhat less than the threshold value V1 as an upper limit of the vehicle speed V that stops motor driving and at which it is predicted that the vehicle speed V will reach the threshold value V1 if driving is continued.

When a motor driving stoppage prediction condition is established, namely, when the state of charge SOC is at or less than the threshold value SOC2 or the vehicle speed V is at or above the threshold value V2 (step S220), the CPU 52 outputs a display signal to the display 72 so that information regarding the established motor driving stoppage prediction condition is displayed on the display 72 (step S230). When a motor driving stoppage prediction condition is not established, namely, when the state of charge SOC is less than the threshold value SOC2 and the vehicle speed V is less than the threshold value V1 (step S220), the CPU 52 ends the present routine without executing processing to display information on the display 72. In the processing of step S230, when it has been determined in the processing of step S220 that the state of charge SOC is less than the threshold value SOC2, a message such as “EV driving may stop because state of charge of battery is decreasing” is displayed on the display 72 so that the driver can be made aware that it is predicted that motor driving will stop because the state of charge of the battery 46 is decreasing. Further, when it is determined in the processing of step S230 that the vehicle speed V is at or above the threshold value V2, a message such as “EV driving may stop because vehicle speed is high” is displayed on the display 72 so that the driver can be made aware that it is predicted that motor driving will stop because the vehicle speed V is high. Thus, when a motor driving stoppage prediction condition is established during motor driving, since the fact that stoppage of motor driving is predicted and information regarding a condition that is established among the conditions assessed at step S220 is displayed on the display 72, the driver can be notified of the fact that stoppage of motor driving is predicted and of the reason why stoppage of motor driving is predicted.

In contrast, when a motor driving stoppage condition is established, namely, when the state of charge SOC is less than the threshold value SOC1 or the vehicle speed V is at or above the threshold value V1 (step S210), motor driving is stopped and the engine 22 is controlled so as to start operation of the engine 22 (step S240). Subsequently, the CPU 52 outputs a lighting signal to the indicator 74 so that the light of the indicator 74 is turned off (step S250), outputs a display signal to the display 72 so that information regarding the condition established among the motor driving stoppage conditions is displayed on the display 72 (step S260), and then ends the present routine. In the processing of step S260, for example, when it has been determined in the processing of step S210 that the state of charge SOC is less than the threshold value SOC1, a message such as “stopping EV driving because state of charge of battery is insufficient” is displayed on the display 72 so that the driver can be made aware that motor driving has stopped because the state of charge of the battery 46 is insufficient, and when it has been determined that the vehicle speed V is at or above the threshold value V1, a message such as “cannot perform EV driving because vehicle speed is high” is displayed on the display 72 so that the driver can be made aware that motor driving has stopped because the vehicle speed V is high. Thus, when a motor driving stoppage condition is established during motor driving, since the light of the indicator 74 is turned off when motor driving is stopped, it is possible to notify the driver that motor driving has stopped. Further, since information regarding a condition that is established among the conditions assessed at step S210 is displayed on the display 72, the driver can be notified of the reason for stopping motor driving.

According to the hybrid vehicle 20 of the embodiment described above, even when the EV switch 69 has been switched on, when the motor driving permission conditions are not established, a warning sound is emitted from the speaker 76 and information regarding a condition that is not established among the motor driving permission conditions is displayed on the display 72, and hence more detailed information regarding the fact that motor driving is not permitted can be notified to the driver. Further, when a motor driving stoppage prediction condition is established in the course of performing motor driving with the EV switch 69 in an on state, information regarding a condition that is established among conditions that predict stoppage of the motor driving is displayed on the display 72, and hence more detailed information regarding the fact that stoppage of the motor driving is predicted can be notified. Furthermore, when a motor driving stoppage condition is established during motor driving, the light of the indicator 74 is turned off and information regarding a condition that is not established among the motor driving stoppage conditions is displayed on the display 72, and hence more detailed information regarding the fact that motor driving has stopped can be notified.

Although according to the hybrid vehicle 20 of the present embodiment, the processings at step S150 and steps S230 and S260 are processings that notify information by displaying characters on the display 72, the information may be notified by any method as long as the driver can recognize the information. For example, an icon or the like may be displayed on the display 72 instead of characters, information may be notified by sound output from the speaker 76 instead of being displayed on the display 72, or information may be notified by both displaying information on the display 72 and sound output from the speaker 76. Further, although in the processing at step S140, the driver is notified to the effect that motor driving can not be performed by sound output from the speaker 76, the driver may also be notified to the effect that motor driving can not be performed by displaying an icon or characters or the like on the display 72 instead of the sound output from the speaker 76. Furthermore, although in the processing at step S130 and step S260, the driver is notified that motor driving is being performed or that motor driving has stopped by turning on or turning off the light of the indicator 74, the driver may also be notified that motor driving has been permitted or that motor driving has stopped by sound output from the speaker 76 instead of turning on or turning off the light of the indicator 74, or the driver may be notified that motor driving has been permitted or that motor driving has stopped by displaying information on the display 72.

According to the hybrid vehicle 20 of the present embodiment, in the processing of step S110 or steps S210 and S220, although respective determinations are made based on conditions using the state of charge SOC of the battery 46, the cooling water temperature Tw of the engine 22, and the vehicle speed V and the like, the respective determinations may also be made based on other conditions such as, for example, the temperature of the battery 46 or the required driving force that is required by the vehicle.

According to the hybrid vehicle 20 of the present embodiment, although the motor drive time control routine illustrated in FIG. 3 is executed when the EV switch 69 is switched on, a configuration may also be adopted in which the routine is executed when performing motor driving, irrespective of whether the EV switch 69 is switched on or off.

According to the hybrid vehicle 20 of the present embodiment, although the motor drive time control routine illustrated in FIG. 3 is executed during motor driving, a configuration may also be adopted that does not execute this kind of control during motor driving.

Although according to the present embodiment, the present invention is applied to a hybrid vehicle including the engine 22; the planetary gear 30 in which the crankshaft 26 of the engine 22 is connected to a carrier and a ring gear is connected to the drive shaft 32; the motor MG1 in which a rotor is connected to a sun gear of the planetary gear 30; and the motor MG2 in which a rotor is connected to the drive shaft 32; application of the present invention is not limited to a hybrid vehicle constructed in this manner, and the present invention can also be applied to any kind of hybrid vehicle capable of performing motor driving and at least driving while operating an engine. Furthermore, the present invention may be applied to a vehicle other than an automobile, and to a control method of such a vehicle.

The correlation between the principal elements of the embodiment and the principal elements of the invention described in the “Disclosure of the Invention” section will now be described. In the embodiment, the engine 22 corresponds to “internal combustion engine”, the motor MG2 corresponds to “motor”, the EV switch 69 that designates the performance of motor driving that drives using the power of the motor MG2 in a state in which operation of the engine 22 has stopped corresponds to “motor driving designation unit”, and the display 72, the indicator 74, and the speaker 76 that are provided in the vicinity of the drivers seat and that notify information correspond to “notification unit”. Further, the hybrid electronic control unit 50 that executes the processing of step S120 that executes control to start motor driving when conditions that permit motor driving are established when the EV switch 69 is switched on in a state in which the engine 22 is operating, the processing of step S130 that outputs a display signal to the indicator 74 to turn on the light of the indicator 74, the processing of step S140 that outputs a sound output to the speaker 76 so that a warning sound is emitted from the speaker 76 while driving in a state in which operation of the engine 22 is continued without starting motor driving when conditions that permit motor driving are not established even though the EV switch 69 has been switched on, and the processing of step S150 that outputs a display signal to the display 72 so that information relating to a condition that is not established among the conditions in the processing of step S110 is displayed on the display 72, corresponds to “control module”. The correspondence of the main elements of the embodiment and the modified embodiment and the main elements of the invention described in the section of “Disclosure of the Invention” does not limit the elements of the invention described in the section of “Disclosure of the Invention”, because the embodiment is one example for concretely describing the best mode for carrying out the invention described in the “Disclosure of the Invention”. More specifically, interpretation of the invention described in the section of “Disclosure of the Invention” should be performed on the basis of the description of the section, and the embodiment is only one concrete example of the invention described in the section of “Disclosure of the Invention”.

Hereinbefore, the embodiments of the present invention have been described with reference to drawings, but the present invention is not limited to the above embodiments. It will be apparent that various modifications can be made to the present invention without departing from the spirit and scope of the present invention.

### INDUSTRIAL APPLICABILITY

The present invention can be used in a manufacturing industry of a vehicle and the like.

1. A vehicle that is capable of driving using a power from an internal combustion engine and a power from a motor, said vehicle comprising:
a motor driving designation unit that designates motor driving that drives using a power from said motor in a state in which an operation of said internal combustion engine has been stopped;
a notification unit capable of notifying predetermined information including at least one of characters, images, sounds and turning on/off of a light; and
a permission determination unit that is to determine whether or not predetermined motor driving permission conditions are established, wherein the predetermined motor driving permission conditions permit the motor to be driven when motor driving is designated by said motor driving designation unit; and
a control module that, when said predetermined motor driving permission conditions are determined to be established, controls said internal combustion engine and said motor such that said vehicle is driven by the motor and also controls said notification unit such that information to the effect that the motor driving is being performed is notified, and when the predetermined motor driving permission conditions are determined not to be established, controls said internal combustion engine and said motor so as to drive in a state in which at least said internal combustion engine is operated and also controls said notification unit such that information by at least one of characters and sounds that show a reason for a fact that the motor driving is not permitted.

2. A vehicle according to claim 1, wherein said control module is a module that controls said notification unit such that, as the information showing a reason for the fact that the motor driving is not permitted, information showing the predetermined motor driving permission condition that is not established is notified.

3. A vehicle according to claim 1, said vehicle comprises a stoppage determination unit that determines whether or not predetermined motor driving stoppage conditions are established, wherein the predetermined motor driving stoppage conditions stop the motor driving in the course of said vehicle being driven by the motor; wherein
said control module is a module that, when said predetermined motor driving stoppage condition is determined to be established, controls said internal combustion engine and said motor such that at least an operation of said internal combustion engine is started and also controls said notification unit such that information by at least one of characters and sounds that show a fact that the motor driving is stopped is notified.

4. A vehicle according to claim 3, said vehicle comprises a stoppage prediction determination unit that determines whether or not it is predicted that the motor driving will stop in the course of said vehicle being driven by the motor driving; wherein
said control module is a module that, when it is determined to be predicted that the motor driving will stop, controls said notification unit such that information by at least one of characters and sounds that show a fact that stoppage of the motor driving is predicted is notified.

5. (canceled)

6. A control method of a vehicle that comprises an internal combustion engine capable of outputting a driving power to an axle, a motor capable of outputting a driving power to an axle, a motor driving designation unit that designates motor driving that drives using a power from said motor in a state in which an operation of said internal combustion engine has been stopped, and a notification unit capable of notifying predetermined information by at least one of characters, images, sounds and turning on/off of light,
wherein, when the motor driving is designated by said motor driving designation unit, when predetermined motor driving permission conditions that permit the motor driving are established, said internal combustion engine and said motor are controlled such that said vehicle is driven by the motor and said notification unit is also controlled so as to notify information to the effect that the motor driving is being performed, and when the predetermined motor driving permission conditions are not established, said internal combustion engine and said motor are controlled so as to drive in a state in which at least operation of said internal combustion engine is continued and said notification unit is controlled such that information by at least one of characters and sounds that show a reason for a fact that the motor driving is not permitted is notified.

7. A vehicle according to claim 6, wherein said notification unit is controlled such that, as the information showing a reason for a fact that the motor driving is not permitted, information information showing the predetermined motor driving permission condition that is not established is notified.

8. A control method of a vehicle according to claim 6, wherein when a predetermined motor driving stoppage condition that stops the motor driving in the course of said vehicle being driven by the motor driving is established, said internal combustion engine and said motor are controlled such that at least an operation of said internal combustion engine is started and said notification unit is also controlled such that information by at least one of characters and sounds that show a fact that the motor driving is stopped is notified.
